(19) United States
(12) Patent Application Publication
(10) Pub. No.: US 2025/0216569 A1
(43) Pub. Date: Jul. 3, 2025

(54) Wavefield Travel-time Inversion using Eikonal Solver

(71) Applicant: Saudi Arabian Oil Company, Dhahran (SA)

(72) Inventors: Young Seo Kim, Dhahran (SA); Hussain J. Salim, Dhahran (SA)

(21) Appl. No.: 18/402,282

(22) Filed: Jan. 2, 2024

(51) Int. Cl. G01V 1/30; G01V 1/28

(52) U.S. Cl. CPC G01V 1/305; G01V 1/282

(57) ABSTRACT

Example methods and systems for wavefield travel-time inversion using eikonal solver are disclosed. One example method includes obtaining multiple first-arrival times of a seismic wavefield measured at multiple receiver locations. Multiple synthetic first-arrival times corresponding to the multiple measured first-arrival times of the seismic wavefield are determined based on an eikonal solver and a near surface velocity model of the seismic wavefield. The near surface velocity model of the seismic wavefield is updated using a wavefield traveltime inversion (WTI) process and based on the multiple synthetic first-arrival times and the multiple measured first-arrival times. The updated near surface velocity model of the seismic wavefield is provided for well location determination.

### TECHNICAL FIELD

The present disclosure relates to computer-implemented methods and systems for wavefield travel-time inversion using eikonal solver.

### BACKGROUND

Accurate near-surface information is important in the construction of subsurface geological models and plays a pivotal role in mitigating hydrocarbon drilling hazards. Consequently, the estimation of near surface P-wave velocity information is a primary objective of geophysical data processing. A reliable near surface velocity model can reduce errors in well location determination.

### SUMMARY

The present disclosure involves methods and systems for wavefield traveltime inversion using eikonal solver. One example method includes obtaining multiple first-arrival times of a seismic wavefield measured at multiple receiver locations. Multiple synthetic first-arrival times corresponding to the multiple measured first-arrival times of the seismic wavefield are determined based on an eikonal solver and a near surface velocity model of the seismic wavefield. The near surface velocity model of the seismic wavefield is updated using a wavefield traveltime inversion (WTI) process and based on the multiple synthetic first-arrival times and the multiple measured first-arrival times. The updated near surface velocity model of the seismic wavefield is provided for well location determination.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, updating the near surface velocity model of the seismic wavefield includes: determining, based on the eikonal solver, multiple simulated traces at the multiple receiver locations; determining, based on the multiple simulated traces, the multiple synthetic first-arrival times, and the multiple measured first-arrival times, an adjoint source for backpropagation in the WTI process; and determining, based on the adjoint source, the near surface velocity model of the seismic wavefield.

In some implementations, determining the multiple simulated traces includes convolving a Ricker wavelet with the multiple synthetic first-arrival times to generate the multiple simulated traces.

In some implementations, determining the near surface velocity model of the seismic wavefield includes: determining, based on the adjoint source and the eikonal solver, a gradient vector; and determining, based on the gradient vector, the near surface velocity model of the seismic wavefield.

In some implementations, determining the gradient vector includes: determining, based on the adjoint source, a backpropagated wavefield; and determining, based on the backpropagated wavefield, the gradient vector.

In some implementations, providing the updated near surface velocity model of the seismic wavefield for well location determination includes: determining, based on the multiple synthetic first-arrival times and the multiple measured first-arrival times, an objective function; determining that the objective function is smaller than a predefined threshold; and in response to determining that the objective function is smaller than the predefined threshold, providing the updated near surface velocity model of the seismic wavefield for well location determination.

In some implementations, updating the near surface velocity model of the seismic wavefield includes: determining an initial model for the near surface velocity model of the seismic wavefield; and determining, based on the eikonal solver and the initial model, the near surface velocity model of the seismic wavefield.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example Wavefield Traveltime Inversion (WTI) process, according to some implementations.

FIG. 2 illustrates a WTI process that uses Modified Energy Ratio (MER) method as a synthetic picker to extract the synthetic first arrivals, according to some implementations.

FIG. 3 illustrates a WTI process that incorporates an eikonal solver, according to some implementations.

FIG. 4 illustrates an example eikonal solver based WTI process with improved speed and robustness, according to some implementations.

FIG. 5A illustrates example synthetic modeled data acquired through wave equation, according to some implementations.

FIG. 5B illustrates example artificial (fake-modeled) traces generated by an eikonal solver, according to some implementations.

FIG. 6A illustrates example synthetic first traveltimes obtained from MER, according to some implementations.

FIG. 6B illustrates example synthetic first traveltimes obtained from an eikonal solver, according to some implementations.

FIG. 7A illustrates an example true velocity model used in WTI processes 200 and 400, according to some implementations.

FIG. 7B illustrates an example initial velocity model used in WTI processes 200 and 400, according to some implementations.

FIG. 7C illustrates an example inverted velocity model obtained from WTI process 200 that uses a synthetic MER picker, according to some implementations.

FIG. 7D illustrates an example inverted velocity model obtained from WTI process 400 that uses an eikonal solver, according to some implementations.

FIG. 8 illustrates an example process for WTI incorporating an eikonal solver, according to some implementations.

FIG. 9 is a block diagram of an example computer system that can be used to provide computational functionalities associated with described algorithms, methods, functions, processes, flows, and procedures, according to some implementations.

FIG. 10 illustrates hydrocarbon production operations that include both one or more field operations and one or more computational operations, which exchange information and control exploration for the production of hydrocarbons, according to some implementations. Like reference numbers and designations in the various drawings indicate like elements.

### DETAILED DESCRIPTION

In geophysical practices, Full Waveform Inversion (FWI) is a technique for constructing near surface velocity models. FWI is an iterative process. It starts with an initial model of the subsurface and then continuously updates this model to reduce the difference between the observed and simulated waveforms. An accurate initial velocity model is important in FWI because the FWI misfit function can include many local minima that can cause FWI to converge toward undesired solutions, e.g., if the initial velocity model is far from the true velocity model. Moreover, three-dimensional FWI can entail substantial computational costs due to the simulation of wave propagation through the wave equation. In some cases, the simulation are carried out using finite difference or element methods.

Wavefield Traveltime Inversion (WTI) can be used to generate the initial velocity model before conducting FWI. However, because the WTI shares the same workflow with FWI, its computational cost is similar to that of FWI. Additionally, to generate a velocity model from WTI, synthetic first arrival travel times can be obtained by an independent first arrival picker program. Even though synthetic gathers do not contain background noises, an amplitude-based picker algorithm may regard wrong events as first arrivals when the near surface velocity model is quite complex. Even when the relevant geological structures are simple, a picker program may make mistakes when refracted and reflected waves come to a receiver at the same time.

This disclosure describes systems and methods that use WTI that incorporates an eikonal solver to obtain a reliable near surface velocity model during the iterative process of WTI. The near surface velocity model can be used to generate seismic images for determining well locations. The disclosed methods replace the aforementioned synthetic picker program with an eikonal solver. With the synthetic picks obtained from the eikonal solver, the WTI can construct an objective function based on the difference between synthetic first arrivals and first break picks from field data. Then, the WTI can generate a velocity model using the objective function. In some cases, the near surface velocity model can be used for long-wavelength static correction in time processing. The near surface velocity model can also be used for deeper model building for depth seismic processing. The depth and/or time migration results obtained from the near surface velocity model can provide geological structure under surface and can be used for finding potential reservoir locations.

The disclosed systems and methods provide many advantages over existing systems. As an example, because the eikonal solver can provide reliable and stable first arrival picks even when the velocity model is complex, the eikonal solver can be used during iterations of WTI process without human intervention. As another example, the eikonal solver can replace forward numerical modeling in a WTI process. Consequently, the speed of the WTI can be improved because it is more computational efficient to use the eikonal solver than the forward numerical modeling.

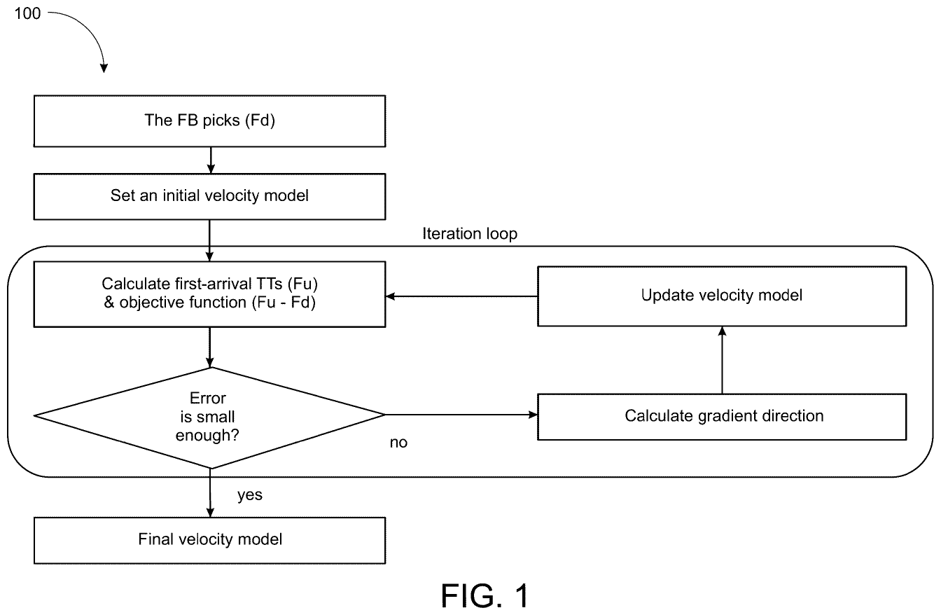

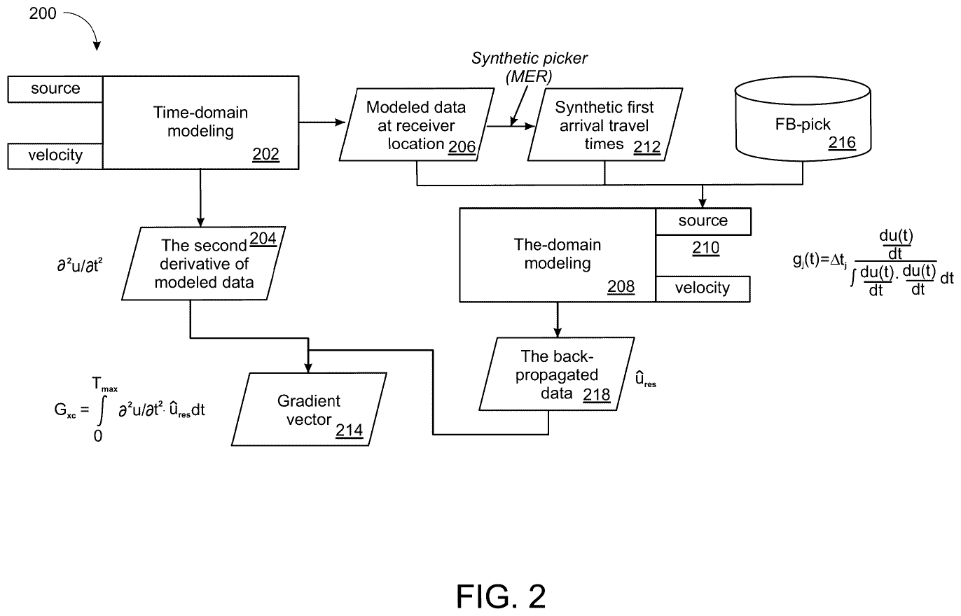

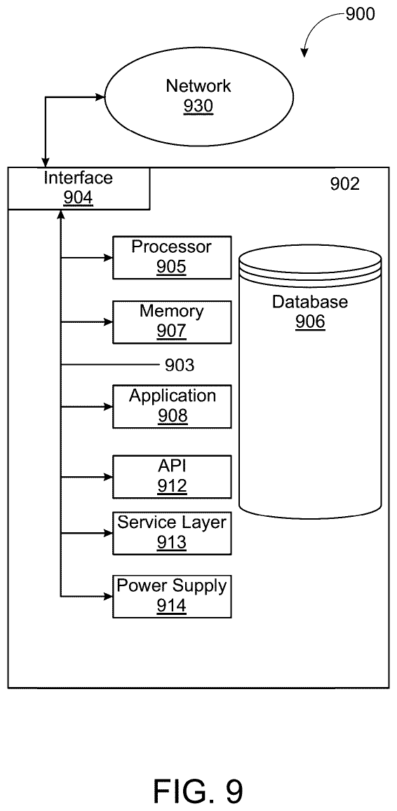

FIG. 1 illustrates an example WTI process 100. In FIG. 1, TTs represent travel times and FB represents first break. For convenience, process 100 will be described as being performed by a system of one or more computers, located in one or more locations, and programmed appropriately in accordance with this specification (e.g., the computer system 900 of FIG. 9). The description of FIG. 1 below may refer to FIG. 2, as FIG. 2 illustrates components that are associated with functions or data used in a WTI process.

In some implementations, a computer system can calculate the objective function in FIG. 1 based on the time difference between the first arrivals in the modeled data, for example, synthetic first arrival travel times 212 in FIG. 2, and observed data, for example, FB-pick 216 in FIG. 2. This is shown in Equation 1 below:

$$E ( m ) = \frac{1}{2} {\sum }_{j = 1}^{{n}_{r}} {‖ {F}_{u , j} ( m ) - {F}_{d , j} ‖}^{2} = \frac{1}{2} {\sum }_{j = 1}^{{n}_{r}} {‖ Δ {t}_{j} ‖}^{2} \qquad ( 1 )$$

In Equation 1, nᵣ is the number of receivers, m is a subsurface P-wave velocity, F_{u,j} and F_{a,j} are first-arrival times picked from modeled data, for example, modeled data 206 in FIG. 2, and field data at the jth receiver, respectively, and Δtⱼ is the time difference between two first-arrival times.

In some implementations, the synthetic waveform of the initial arrival event can be the same as the field-data waveform of the initial arrival, as the WTI process is not concerned with the amplitude information of a wavefield. Therefore, the field wavefield “d” can be replaced with the synthetic wavefield u. The computer system can determine the WTI adjoint source g; at the jth receiver, for example, source 210 in FIG. 2, using Equation 2:

$${g}_{j} ( t ) = Δ {t}_{j} \frac{\frac{du ( t )}{dt}}{\int \frac{du ( t )}{dt} \cdot \frac{du ( t )}{dt} dt} \qquad ( 2 )$$

In some implementations, a gradient vector for the velocity model update in the iteration loop, for example, gradient vector 214 in FIG. 2, can be determined as the cross-correlation of the second derivatives of the synthetic wavefield with respect to time and a backpropagated wavefield. In some cases, preconditioned conjugate gradient method can be used for velocity model update. The backpropagated wavefield ûᵣₑₛ, for example, the back-propagated data 218 in FIG. 2, can be obtained by performing numerical modeling and by using the adjoint source in Equation 2 as a source term. The gradient vector G_{xc} can be determined using Equation 3 as follows:

$${G}_{xc} = {\int }_{0}^{{T}_{max}} {\partial }^{2} u / \partial {t}^{2} \cdot {\hat{u}}_{r e s} dt \qquad ( 3 )$$

In some implementations, the computer system can calculate modeled data Fᵤ at each receiver location and for each shot to build the objective function during each iteration. To select the first arrivals from the synthetic traces, the computer system can use the Modified Energy Ratio (MER) method, which can be effective in noise-free data. The computer system can determine seismic attribute s using MER, as shown in Equation 4 below:

$$M ( t ) = {\{ ( {\sum }_{i = t}^{t + {n}_{e}} \vert {s}_{i}^{2} \vert / {\sum }_{i = t - {n}_{e}}^{t} \vert {s}_{i}^{2} \vert ) \vert {s}_{i} \vert \}}^{3} \qquad ( 4 )$$

In Equation 4, sᵢ is an amplitude of a seismic trace at the i-th time index and nₑ is a length of a moving window. In some examples, the computer system can pick the synthetic first arrival travel times at which M(t) has the maximum value in each trace.

FIG. 2 illustrates a WTI process 200 that uses MER as a synthetic picker to extract the synthetic first arrivals. A computer system can use WTI process 200 to implement an iteration step in the iteration loop in WTI process 100. The near-surface velocity model can be intricate, because different signals from reflections and refractions may arrive at the same time. Therefore, the MER method, which is used as a picker, can mistakenly select a later event as the first arrival. This issue can arise after several iterations. Furthermore, to enhance the visibility of the initial arrival signals, a computer system can apply scaling to the synthetic data. Choosing the scaling factors depends on the peak frequency of the synthetic data and the complexity of the velocity model. Therefore, the WTI process illustrated in FIG. 2 may not be robust when the velocity model changes in every iteration without human's intervention.

To enhance the robustness of WTI process 200, the computer system can use a grid-based travel-time calculation method by solving the eikonal equation through finite difference approximation.

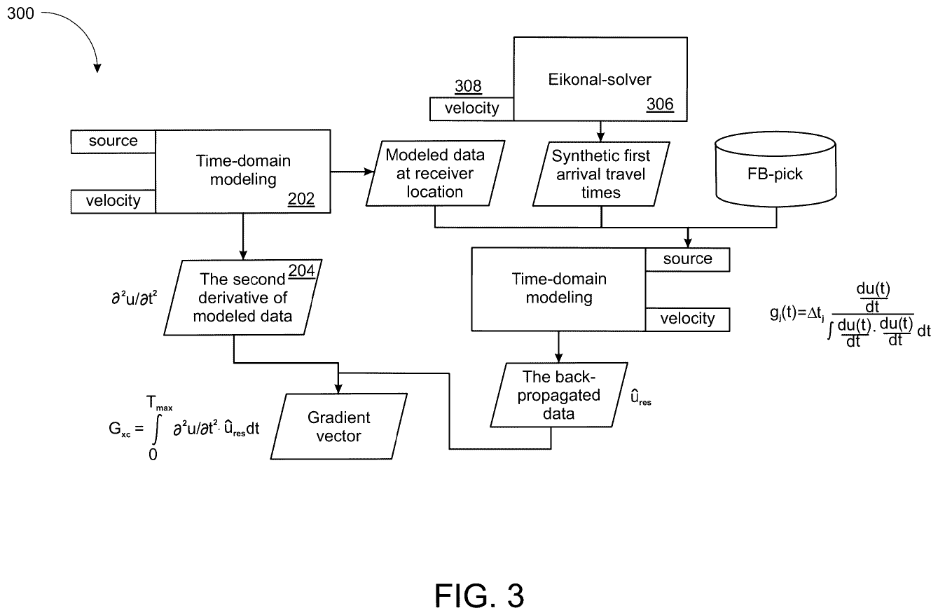

FIG. 3 illustrates a WTI process 300 that incorporates an eikonal solver. A computer system can use WTI process 300 to implement an iteration step in the iteration loop in FIG. 1. While the eikonal solver 306 can provide stable first arrival traveltimes from a velocity model, the first arrival traveltimes computed by the eikonal solver may not match the first arrivals obtained from the first wavefields derived by the wave equation, for example, when the velocity model has complex geological structure. Therefore, the synthetic wavefield selected by the eikonal solver may not align with the accurate first-arrival wavefield obtained through the wave equation in the velocity model having the complex geological structure. WTI process 300 can introduce extra computational steps due to the use of the eikonal solver, in contrast to FWI based methods. Consequently, the computation time for WTI process 300 can be longer than that for an FWI based method.

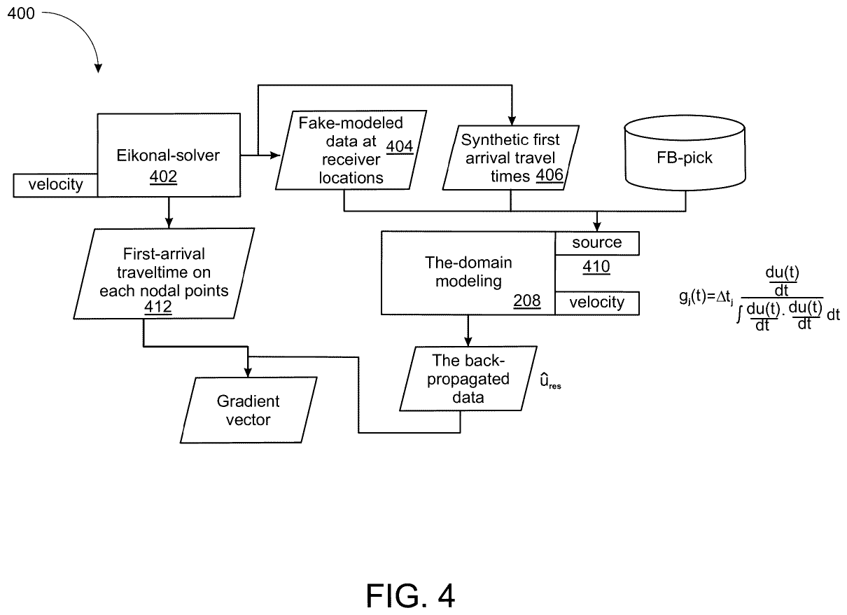

FIG. 4 illustrates an example eikonal solver based WTI process 400 with improved speed and robustness. A computer system can use WTI process 400 to implement an iteration step in the iteration loop in FIG. 1. In WTI process 400, the computer system replaces the forward numerical modeling in WTI process 300, i.e., time-domain modeling 202, with eikonal solver 402. In some implementations, eikonal solver 402 can be significantly faster in computation when compared to time-domain modeling 202 that solves wave equations using finite difference methods. Consequently, replacing time-domain modeling 202 with eikonal solver 402 can lead to a substantial reduction in computational costs, for example, when the velocity model has finer grid sizes.

In some implementations, the computer system can generate simulated traces at each receiver location j, i.e., fake-modeled data 404 at each receiver location j, to create the adjoint source gⱼ(t), i.e., source 410, for backpropagation. Since the computer system has access to the synthetic first arrival travel times 406 computed by eikonal solver 402, the computer system can generate simulated traces by convolving a specified source wavelet, for example, a Ricker wavelet, with the first arrivals obtained from the eikonal solver, i.e., synthetic first arrival travel times 406.

In some implementations, WTI process 400 can use eikonal solver 402 to generate first-arrival traveltime 412 on each nodal point (e.g., each grid point used to delineate the velocity model) in order to eliminate the need to store the second derivatives of the modeled wavefield ∂²u/∂t² 204 at each time step or imaging time step. In some cases, the process of storing the second derivatives of the modeled wavefield can be a bottleneck in efficient FWI or WTI implementations, because of the large size of each wavefield (i.e., snapshot) at each time step. However, during WTI process 400, the computer system does not need to save snapshots at every time step. Instead, the computer system only needs to store one cube (nx*ny*nz) containing the first arrival traveltimes in a storage device, for example, in a D-RAM. Consequently, WTI process 400 can avoid the time-consuming data transfer between the D-RAM and a hard disk that would have been used to store the second derivatives of the modeled wavefield. The computer system can determine the gradient vector G_{wti} using Equation 5 as follows:

$${G}_{wti} ( x ) = ( - 1 ) * {\tilde{u}}_{r e s} ( x , t ) , \text{} if int ( \frac{t c ( x )}{dt} + 0.5 ) + int ( \frac{t}{dt} + 0.5 ) = \frac{{T}_{max}}{dt} = {Nt}_{max} \qquad ( 5 )$$

where x is an image location of the model, ũᵣₑₛ is the backpropagated wavefield, t is at a current time during the backpropagation, Tₘₐₓ is the total recording time, dt is each time step, and tc(x) is the first arrival travel time at the location x.

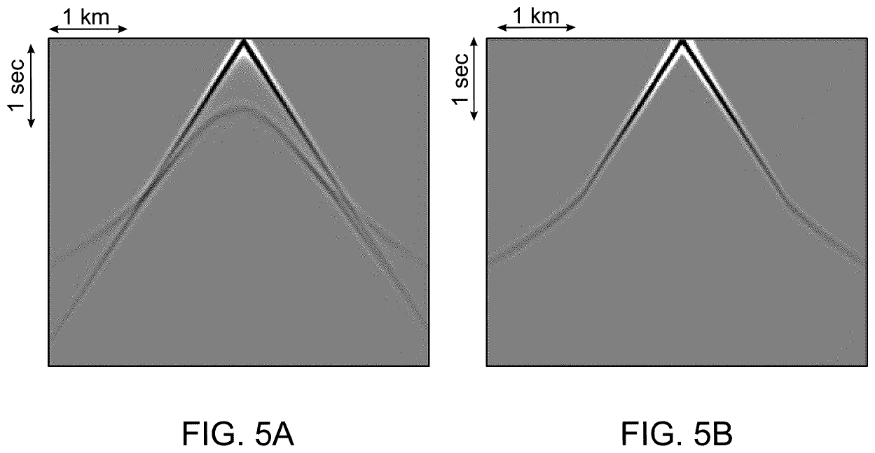

FIG. 5A illustrates example synthetic modeled data acquired through wave equation. FIG. 5B illustrates example artificial (fake-modeled) traces generated by an eikonal solver. In some implementations, to generate the example data in FIGS. 5A and 5B, a computer system can use a significantly smoothed velocity model to initiate a WTI process, for example, WTI process 400. As shown in FIG. 5B, the artificial traces depict the first arrival events, even though the artificial traces may not encompass other seismic events. Because the WTI process necessitates the first arrival events for adjoint source computation, the computer system can use the artificial traces to construct the adjoint source and calculate the WTI objective function.

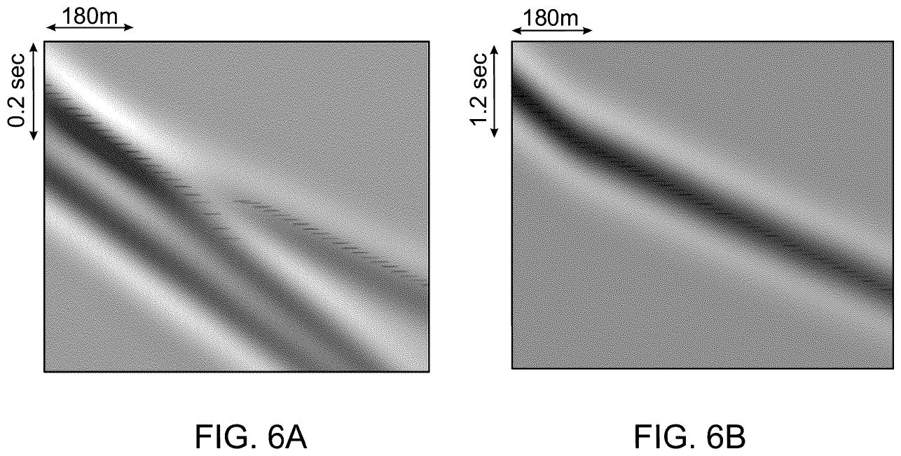

FIG. 6A illustrates example synthetic first traveltimes obtained from MER. FIG. 6B illustrates example synthetic first traveltimes obtained from an eikonal solver. In FIG. 6A, the first-arrival picks obtained from MER are superimposed onto the synthetic data. As shown in FIG. 6A, MER tends to select a later event as a first arrival, even when a computer system uses a heavily smoothed velocity to initialize numerical modeling. In contrast, in FIG. 6B, the eikonal solver generates synthetic first arrival travel times reliably.

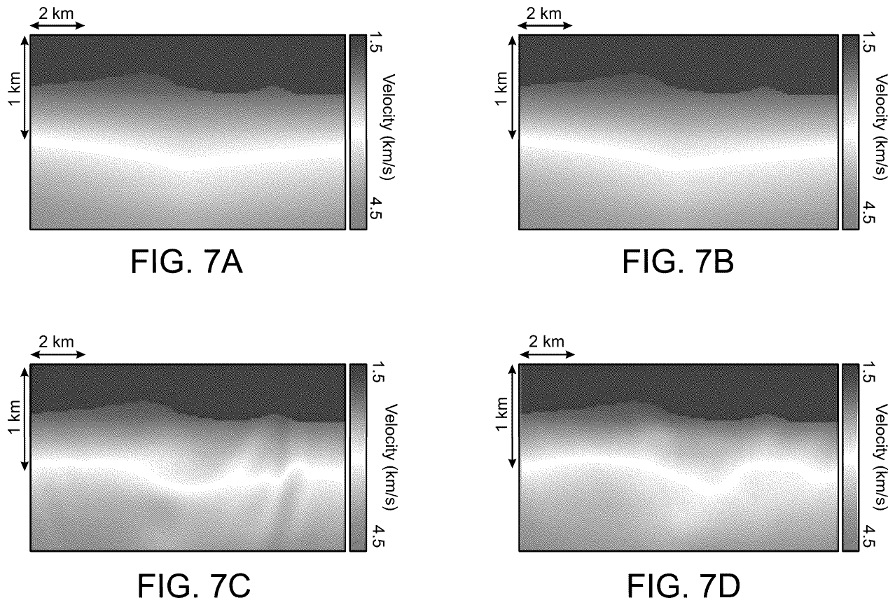

FIG. 7A illustrates an example true velocity model used in WTI processes 200 and 400. FIG. 7B illustrates an example initial velocity model used in WTI processes 200 and 400.

FIG. 7C illustrates an example inverted velocity model obtained from WTI process 200 that uses a synthetic MER picker. FIG. 7C shows jagged and irregular artifacts on the right side of the inverted velocity model. In some implementations, the jagged and irregular artifacts shown in FIG. 7C stem from the instability of the picks made by the MER picker. As the velocity model complexity increases, the MER picker's instability becomes more pronounced.

In contrast, FIG. 7D illustrates an example inverted velocity model obtained from WTI process 400 that uses an eikonal solver. As shown in FIG. 7D, the inverted velocity model closely follows the trend of the true velocity model in FIG. 7A. The inverted velocity model in FIG. 7D also lacks jagged or irregular artifacts. Moreover, in each iteration, WTI process 400 is approximately 1.5 times faster than WTI process 200. The improved speed can be attributed to the fact that WTI process 400 only uses one numerical modeling step, i.e., time-domain modeling 208, for the back-propagation process, whereas WTI process 200 includes two numerical modeling steps, i.e., time-domain modeling 202 and time-domain modeling 208.

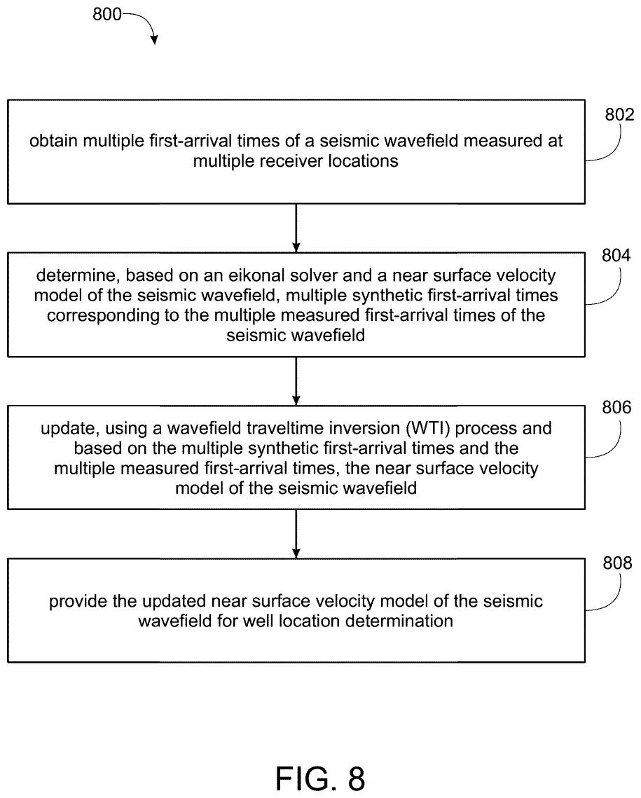

FIG. 8 illustrates an example process 800 for WTI incorporating an eikonal solver. For convenience, process 800 will be described as being performed by a computer system having one or more computers located in one or more locations and programmed appropriately in accordance with this specification. An example of the computer system is the computer system 900 illustrated in FIG. 9.

At 802, a computer system obtains multiple first-arrival times of a seismic wavefield measured at multiple receiver locations.

At 804, the computer system determines, based on an eikonal solver and a near surface velocity model of the seismic wavefield, multiple synthetic first-arrival times corresponding to the multiple measured first-arrival times of the seismic wavefield.

At 806, the computer system updates, using a wavefield traveltime inversion (WTI) process and based on the multiple synthetic first-arrival times and the multiple measured first-arrival times, the near surface velocity model of the seismic wavefield.

At 808, the computer system provides the updated near surface velocity model of the seismic wavefield for well location determination.

FIG. 9 is a block diagram of an example computer system 900 that can be used to provide computational functionalities associated with described algorithms, methods, functions, processes, flows, and procedures, according to some implementations of the present disclosure. In some implementations, the computer system performing process 100, 200, 300, or 400 can be the computer system 900, include the computer system 900, or the computer system performing process 100, 200, 300, or 400 can communicate with the computer system 900.

The illustrated computer 902 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 902 can include a Smart Embedded Management Agent (SEMA), such as a built-in ADLINK SEMA 2.2, and a video sync technology, such as Quick Sync Video technology supported by ADLINK MSDK+. In some examples, the computer 902 can include the MXE-5400 Series processor-based fanless embedded computer by ADLINK, though the computer 902 can take other forms or include other components.

The computer 902 can serve in a role as a client, a network component, a server, a database, a persistency, or components of a computer system for performing the subject matter described in the present disclosure. The illustrated computer 902 is communicably coupled with a network 930. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 930 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 903. In some implementations, any or all of the components of the computer 902, including hardware or software components, can interface with each other or the interface 904 (or a combination of both), over the system bus. Interfaces can use an application programming interface (API) 912, a service layer 913, or a combination of the API 912 and service layer 913. The API 912 can include specifications for routines, data structures, and object classes. The API 912 can be either computer-language independent or dependent. The API 912 can refer to a complete interface, a single function, or a set of APIs 912.

The service layer 913 can provide software services to the computer 902 and other components (whether illustrated or not) that are communicably coupled to the computer 902. The functionality of the computer 902 can be accessible for all service consumers using this service layer 913. Software services, such as those provided by the service layer 913, can provide reusable, defined functionalities through a defined interface. For example, the interface can be software written in JAVA, C++, or a language providing data in extensible markup language (XML) format. While illustrated as an integrated component of the computer 902, in alternative implementations, the API 912 or the service layer 913 can be stand-alone components in relation to other components of the computer 902 and other components communicably coupled to the computer 902. Moreover, any or all parts of the API 912 or the service layer 913 can be implemented as child or sub-modules of another software module, enterprise application, or hardware module without departing from the scope of the present disclosure.

The computer 902 can include an interface 904. Although illustrated as a single interface 904 in FIG. 9, two or more interfaces 904 can be used according to particular needs, desires, or particular implementations of the computer 902 and the described functionality. The interface 904 can be used by the computer 902 for communicating with other systems that are connected to the network 930 (whether illustrated or not) in a distributed environment. Generally, the interface 904 can include, or be implemented using, logic encoded in software or hardware (or a combination of software and hardware) operable to communicate with the network 930. More specifically, the interface 904 can include software supporting one or more communication protocols associated with communications. As such, the network 930 or the interface's hardware can be operable to communicate physical signals within and outside of the illustrated computer 902.

The computer 902 includes a processor 905. Although illustrated as a single processor 905 in FIG. 9, two or more processors 905 can be used according to particular needs, desires, or particular implementations of the computer 902 and the described functionality. Generally, the processor 905 can execute instructions and manipulate data to perform the operations of the computer 902, including operations using algorithms, methods, functions, processes, flows, and procedures as described in the present disclosure.

The computer 902 can also include a database 906 that can hold data for the computer 902 and other components connected to the network 930 (whether illustrated or not). For example, database 906 can be an in-memory, conventional, or a database storing data consistent with the present disclosure. In some implementations, the database 906 can be a combination of two or more different database types (for example, hybrid in-memory and conventional databases) according to particular needs, desires, or particular implementations of the computer 902 and the described functionality. Although illustrated as a single database 906 in FIG. 9, two or more databases (of the same, different, or combination of types) can be used according to particular needs, desires, or particular implementations of the computer 902 and the described functionality. While database 906 is illustrated as an internal component of the computer 902, in alternative implementations, database 906 can be external to the computer 902.

The computer 902 also includes a memory 907 that can hold data for the computer 902 or a combination of components connected to the network 930 (whether illustrated or not). Memory 907 can store any data consistent with the present disclosure. In some implementations, memory 907 can be a combination of two or more different types of memory (for example, a combination of semiconductor and magnetic storage) according to particular needs, desires, or particular implementations of the computer 902 and the described functionality. Although illustrated as a single memory 907 in FIG. 9, two or more memories 907 (of the same, different, or combination of types) can be used according to particular needs, desires, or particular implementations of the computer 902 and the described functionality. While memory 907 is illustrated as an internal component of the computer 902, in alternative implementations, memory 907 can be external to the computer 902.

An application 908 can be an algorithmic software engine providing functionality according to particular needs, desires, or particular implementations of the computer 902 and the described functionality. For example, an application 908 can serve as one or more components, modules, or applications 908. Multiple applications 908 can be implemented on the computer 902. Each application 908 can be internal or external to the computer 902.

The computer 902 can also include a power supply 914. The power supply 914 can include a rechargeable or non-rechargeable battery that can be configured to be either user- or non-user-replaceable. In some implementations, the power supply 914 can include power-conversion and management circuits, including recharging, standby, and power management functionalities. In some implementations, the power-supply 914 can include a power plug to allow the computer 902 to be plugged into a wall socket or a power source to, for example, power the computer 902 or recharge a rechargeable battery.

There can be any number of computers 902 associated with, or external to, a computer system including computer 902, with each computer 902 communicating over network 930. Further, the terms “client”, “user”, and other appropriate terminology can be used interchangeably without departing from the scope of the present disclosure. Moreover, the present disclosure contemplates that many users can use one computer 902 and one user can use multiple computers 902.

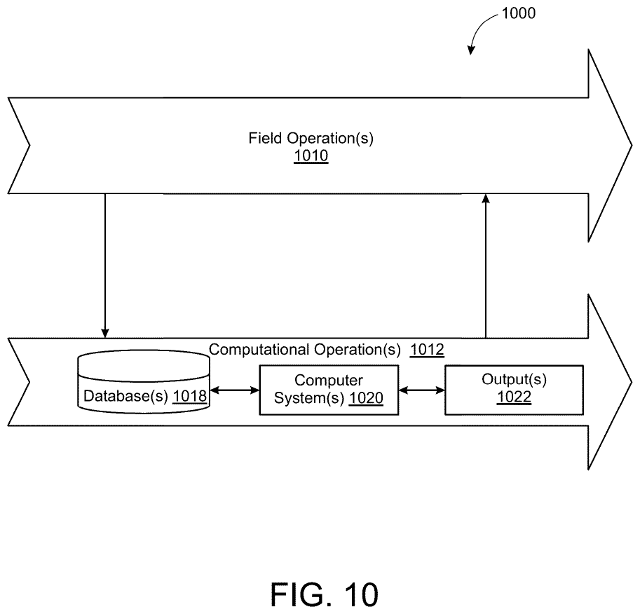

FIG. 10 illustrates hydrocarbon production operations 1000 that include both one or more field operations 1010 and one or more computational operations 1012, which exchange information and control exploration for the production of hydrocarbons. In some implementations, outputs of techniques of the present disclosure can be performed before, during, or in combination with the hydrocarbon production operations 1000, specifically, for example, either as field operations 1010 or computational operations 1012, or both.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser. Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### Embodiments

Embodiment 1: A computer-implemented method comprising obtaining a plurality of first-arrival times of a seismic wavefield measured at a plurality of receiver locations; determining, based on an eikonal solver and a near surface velocity model of the seismic wavefield, a plurality of synthetic first-arrival times corresponding to the plurality of measured first-arrival times of the seismic wavefield; updating, using a wavefield traveltime inversion (WTI) process and based on the plurality of synthetic first-arrival times and the plurality of measured first-arrival times, the near surface velocity model of the seismic wavefield; and providing the updated near surface velocity model of the seismic wavefield for well location determination.

Embodiment 2: The computer-implemented method of embodiment 1, wherein updating the near surface velocity model of the seismic wavefield comprises: determining, based on the eikonal solver, a plurality of simulated traces at the plurality of receiver locations; determining, based on the plurality of simulated traces, the plurality of synthetic first-arrival times, and the plurality of measured first-arrival times, an adjoint source for backpropagation in the WTI process; and determining, based on the adjoint source, the near surface velocity model of the seismic wavefield.

Embodiment 3: The computer-implemented method of embodiment 2, wherein determining the plurality of simulated traces comprises convolving a Ricker wavelet with the plurality of synthetic first-arrival times to generate the plurality of simulated traces.

Embodiment 4: The computer-implemented method of embodiment 2 or 3, wherein determining the near surface velocity model of the seismic wavefield comprises: determining, based on the adjoint source and the eikonal solver, a gradient vector; and determining, based on the gradient vector, the near surface velocity model of the seismic wavefield.

Embodiment 5: The computer-implemented method of embodiment 4, wherein determining the gradient vector comprises: determining, based on the adjoint source, a backpropagated wavefield; and determining, based on the backpropagated wavefield, the gradient vector.

Embodiment 6: The computer-implemented method of any one of embodiments 1 to 5, wherein providing the updated near surface velocity model of the seismic wavefield for well location determination comprises: determining, based on the plurality of synthetic first-arrival times and the plurality of measured first-arrival times, an objective function; determining that the objective function is smaller than a predefined threshold; and in response to determining that the objective function is smaller than the predefined threshold, providing the updated near surface velocity model of the seismic wavefield for well location determination.

Embodiment 7: The computer-implemented method of any one of embodiments 1 to 6, wherein updating the near surface velocity model of the seismic wavefield comprises: determining an initial model for the near surface velocity model of the seismic wavefield; and determining, based on the eikonal solver and the initial model, the near surface velocity model of the seismic wavefield.

Embodiment 8: A non-transitory computer-readable medium storing one or more instructions executable by a computer system to perform operations comprising: obtaining a plurality of first-arrival times of a seismic wavefield measured at a plurality of receiver locations; determining, based on an eikonal solver and a near surface velocity model of the seismic wavefield, a plurality of synthetic first-arrival times corresponding to the plurality of measured first-arrival times of the seismic wavefield; updating, using a wavefield traveltime inversion (WTI) process and based on the plurality of synthetic first-arrival times and the plurality of measured first-arrival times, the near surface velocity model of the seismic wavefield; and providing the updated near surface velocity model of the seismic wavefield for well location determination.

Embodiment 9: The non-transitory computer-readable medium of embodiment 8, wherein updating the near surface velocity model of the seismic wavefield comprises: determining, based on the eikonal solver, a plurality of simulated traces at the plurality of receiver locations; determining, based on the plurality of simulated traces, the plurality of synthetic first-arrival times, and the plurality of measured first-arrival times, an adjoint source for backpropagation in the WTI process; and determining, based on the adjoint source, the near surface velocity model of the seismic wavefield.

Embodiment 10: The non-transitory computer-readable medium of embodiment 9, wherein determining the plurality of simulated traces comprises convolving a Ricker wavelet with the plurality of synthetic first-arrival times to generate the plurality of simulated traces.

Embodiment 11: The non-transitory computer-readable medium of embodiment 9 or 10, wherein determining the near surface velocity model of the seismic wavefield comprises: determining, based on the adjoint source and the eikonal solver, a gradient vector; and determining, based on the gradient vector, the near surface velocity model of the seismic wavefield.

Embodiment 12: The non-transitory computer-readable medium of embodiment 11, wherein determining the gradient vector comprises: determining, based on the adjoint source, a backpropagated wavefield; and determining, based on the backpropagated wavefield, the gradient vector.

Embodiment 13: The non-transitory computer-readable medium of any one of embodiments 8 to 12, wherein providing the updated near surface velocity model of the seismic wavefield for well location determination comprises: determining, based on the plurality of synthetic first-arrival times and the plurality of measured first-arrival times, an objective function; determining that the objective function is smaller than a predefined threshold; and in response to determining that the objective function is smaller than the predefined threshold, providing the updated near surface velocity model of the seismic wavefield for well location determination.

Embodiment 14: The non-transitory computer-readable medium of any one of embodiments 9 to 13, wherein updating the near surface velocity model of the seismic wavefield comprises: determining an initial model for the near surface velocity model of the seismic wavefield; and determining, based on the eikonal solver and the initial model, the near surface velocity model of the seismic wavefield.

Embodiment 15: A computer-implemented system, comprising one or more computers; and one or more computer memory devices interoperably coupled with the one or more computers and having tangible, non-transitory, machine-readable media storing one or more instructions that, when executed by the one or more computers, perform one or more operations comprising: obtaining a plurality of first-arrival times of a seismic wavefield measured at a plurality of receiver locations; determining, based on an eikonal solver and a near surface velocity model of the seismic wavefield, a plurality of synthetic first-arrival times corresponding to the plurality of measured first-arrival times of the seismic wavefield; updating, using a wavefield traveltime inversion (WTI) process and based on the plurality of synthetic first-arrival times and the plurality of measured first-arrival times, the near surface velocity model of the seismic wavefield; and providing the updated near surface velocity model of the seismic wavefield for well location determination.

Embodiment 16: The computer-implemented system of embodiment 15, wherein updating the near surface velocity model of the seismic wavefield comprises: determining, based on the eikonal solver, a plurality of simulated traces at the plurality of receiver locations; determining, based on the plurality of simulated traces, the plurality of synthetic first-arrival times, and the plurality of measured first-arrival times, an adjoint source for backpropagation in the WTI process; and determining, based on the adjoint source, the near surface velocity model of the seismic wavefield.

Embodiment 17: The computer-implemented system of embodiment 16, wherein determining the plurality of simulated traces comprises convolving a Ricker wavelet with the plurality of synthetic first-arrival times to generate the plurality of simulated traces.

Embodiment 18: The computer-implemented system of embodiment 16 or 17, wherein determining the one or more production rates comprises determining, at the production rate of the wellbore, a shear failure potential around the wellbore based on a shear failure criterion.

Embodiment 19: The computer-implemented system of embodiment 18, wherein determining the gradient vector comprises: determining, based on the adjoint source, a backpropagated wavefield; and determining, based on the backpropagated wavefield, the gradient vector.

Embodiment 20: The computer-implemented system of any one of embodiments 15 to 19, wherein providing the updated near surface velocity model of the seismic wavefield for well location determination comprises: determining, based on the plurality of synthetic first-arrival times and the plurality of measured first-arrival times, an objective function; determining that the objective function is smaller than a predefined threshold; and in response to determining that the objective function is smaller than the predefined threshold, providing the updated near surface velocity model of the seismic wavefield for well location determination.

We claim:

1. A computer-implemented method comprising:
obtaining a plurality of first-arrival times of a seismic wavefield measured at a plurality of receiver locations;
determining, based on an eikonal solver and a near surface velocity model of the seismic wavefield, a plurality of synthetic first-arrival times corresponding to the plurality of measured first-arrival times of the seismic wavefield;
updating, using a wavefield traveltime inversion (WTI) process and based on the plurality of synthetic first-arrival times and the plurality of measured first-arrival times, the near surface velocity model of the seismic wavefield; and
providing the updated near surface velocity model of the seismic wavefield for well location determination.

2. The computer-implemented method of claim 1, wherein updating the near surface velocity model of the seismic wavefield comprises:
determining, based on the eikonal solver, a plurality of simulated traces at the plurality of receiver locations;
determining, based on the plurality of simulated traces, the plurality of synthetic first-arrival times, and the plurality of measured first-arrival times, an adjoint source for backpropagation in the WTI process; and
determining, based on the adjoint source, the near surface velocity model of the seismic wavefield.

3. The computer-implemented method of claim 2, wherein determining the plurality of simulated traces comprises convolving a Ricker wavelet with the plurality of synthetic first-arrival times to generate the plurality of simulated traces.

4. The computer-implemented method of claim 2, wherein determining the near surface velocity model of the seismic wavefield comprises:
determining, based on the adjoint source and the eikonal solver, a gradient vector; and
determining, based on the gradient vector, the near surface velocity model of the seismic wavefield.

5. The computer-implemented method of claim 4, wherein determining the gradient vector comprises:
determining, based on the adjoint source, a backpropagated wavefield; and
determining, based on the backpropagated wavefield, the gradient vector.

6. The computer-implemented method of claim 1, wherein providing the updated near surface velocity model of the seismic wavefield for well location determination comprises:
determining, based on the plurality of synthetic first-arrival times and the plurality of measured first-arrival times, an objective function;
determining that the objective function is smaller than a predefined threshold; and
in response to determining that the objective function is smaller than the predefined threshold, providing the updated near surface velocity model of the seismic wavefield for well location determination.

7. The computer-implemented method of claim 1, wherein updating the near surface velocity model of the seismic wavefield comprises:
determining an initial model for the near surface velocity model of the seismic wavefield; and
determining, based on the eikonal solver and the initial model, the near surface velocity model of the seismic wavefield.

8. A non-transitory computer-readable medium storing one or more instructions executable by a computer system to perform operations comprising:
obtaining a plurality of first-arrival times of a seismic wavefield measured at a plurality of receiver locations;
determining, based on an eikonal solver and a near surface velocity model of the seismic wavefield, a plurality of synthetic first-arrival times corresponding to the plurality of measured first-arrival times of the seismic wavefield;
updating, using a wavefield traveltime inversion (WTI) process and based on the plurality of synthetic first-arrival times and the plurality of measured first-arrival times, the near surface velocity model of the seismic wavefield; and
providing the updated near surface velocity model of the seismic wavefield for well location determination.

9. The non-transitory computer-readable medium of claim 8, wherein updating the near surface velocity model of the seismic wavefield comprises:
determining, based on the eikonal solver, a plurality of simulated traces at the plurality of receiver locations;
determining, based on the plurality of simulated traces, the plurality of synthetic first-arrival times, and the plurality of measured first-arrival times, an adjoint source for backpropagation in the WTI process; and
determining, based on the adjoint source, the near surface velocity model of the seismic wavefield.

10. The non-transitory computer-readable medium of claim 9, wherein determining the plurality of simulated traces comprises convolving a Ricker wavelet with the plurality of synthetic first-arrival times to generate the plurality of simulated traces.

11. The non-transitory computer-readable medium of claim 9, wherein determining the near surface velocity model of the seismic wavefield comprises:
determining, based on the adjoint source and the eikonal solver, a gradient vector; and
determining, based on the gradient vector, the near surface velocity model of the seismic wavefield.

12. The non-transitory computer-readable medium of claim 11, wherein determining the gradient vector comprises:
determining, based on the adjoint source, a backpropagated wavefield; and
determining, based on the backpropagated wavefield, the gradient vector.

13. The non-transitory computer-readable medium of claim 9, wherein providing the updated near surface velocity model of the seismic wavefield for well location determination comprises:
determining, based on the plurality of synthetic first-arrival times and the plurality of measured first-arrival times, an objective function;
determining that the objective function is smaller than a predefined threshold; and
in response to determining that the objective function is smaller than the predefined threshold, providing the updated near surface velocity model of the seismic wavefield for well location determination.

14. The non-transitory computer-readable medium of claim 9, wherein updating the near surface velocity model of the seismic wavefield comprises:
determining an initial model for the near surface velocity model of the seismic wavefield; and
determining, based on the eikonal solver and the initial model, the near surface velocity model of the seismic wavefield.

15. A computer-implemented system, comprising:
one or more computers; and
one or more computer memory devices interoperably coupled with the one or more computers and having tangible, non-transitory, machine-readable media storing one or more instructions that, when executed by the one or more computers, cause the computer-implemented system to perform one or more operations comprising:
obtaining a plurality of first-arrival times of a seismic wavefield measured at a plurality of receiver locations;
determining, based on an eikonal solver and a near surface velocity model of the seismic wavefield, a plurality of synthetic first-arrival times corresponding to the plurality of measured first-arrival times of the seismic wavefield;
updating, using a wavefield traveltime inversion (WTI) process and based on the plurality of synthetic first-arrival times and the plurality of measured first-arrival times, the near surface velocity model of the seismic wavefield; and
providing the updated near surface velocity model of the seismic wavefield for well location determination.

16. The computer-implemented system of claim 15, wherein updating the near surface velocity model of the seismic wavefield comprises:
determining, based on the eikonal solver, a plurality of simulated traces at the plurality of receiver locations;
determining, based on the plurality of simulated traces, the plurality of synthetic first-arrival times, and the plurality of measured first-arrival times, an adjoint source for backpropagation in the WTI process; and
determining, based on the adjoint source, the near surface velocity model of the seismic wavefield.

17. The computer-implemented system of claim 16, wherein determining the plurality of simulated traces comprises convolving a Ricker wavelet with the plurality of synthetic first-arrival times to generate the plurality of simulated traces.

18. The computer-implemented system of claim 16, wherein determining the near surface velocity model of the seismic wavefield comprises:
determining, based on the adjoint source and the eikonal solver, a gradient vector; and
determining, based on the gradient vector, the near surface velocity model of the seismic wavefield.

19. The computer-implemented system of claim 18, wherein determining the gradient vector comprises:
determining, based on the adjoint source, a backpropagated wavefield; and
determining, based on the backpropagated wavefield, the gradient vector.

20. The computer-implemented system of claim 15, wherein providing the updated near surface velocity model of the seismic wavefield for well location determination comprises:
determining, based on the plurality of synthetic first-arrival times and the plurality of measured first-arrival times, an objective function;
determining that the objective function is smaller than a predefined threshold; and
in response to determining that the objective function is smaller than the predefined threshold, providing the updated near surface velocity model of the seismic wavefield for well location determination.
